(19) United States
(12) Patent Application Publication
(10) Pub. No.: US 2003/0131675 A1
(43) Pub. Date: Jul. 17, 2003

(54) Gear change transmission

(76) Inventor: John Michael Lipman, Banbury Road Ettington (GB)

Correspondence Address: ROSENTHAL & OSHA L.L.P., 1221 MCKINNEY AVENUE, SUITE 2800, HOUSTON, TX, 77010, US

(21) Appl. No.: 10/239,384

(22) PCT Filed: Mar. 16, 2001
(86) PCT No.: PCT/GB01/01178

(30) Foreign Application Priority Data
Mar. 20, 2000 (GB) 0006705.8

(51) Int. Cl. F16H 3/10

(52) U.S. Cl. 74/333; 74/359

(57) ABSTRACT

At least one gearwheel of each meshing pair of gearwheels (10, 12, 14, 16, 20, 22, 24, 26) includes two respective selectively operable rotary locks which are adapted to lock the gearwheels to the associated shaft so that it rotates therewith in respective opposite directions. Each rotary lock comprises a plurality of rollers (34), whose positions relative to one another are maintained by a respective cage (36, 38) and which are received in respective spaced defined between an internal cylindrical surface on the associated gearwheel and a respective portion (32) of the surface of the associated shaft. The spaces associated with the two sets of rolling bodies (34) have a width in the radial direction of the shaft which progressively decreases from a maximum value in opposite circumferential directions of the shaft, whereby the two cages (36, 38) are movable in respective opposite circumferential directions between a freewheel position and a locked position. Each cage (36, 38) is acted on by at least one actuating mechanism (44) which is selectively operable to move the cage and thus the associated rollers in the circumferential direction in which the width of the associated spaces decreases from the freewheel position to the locked position.

The present invention relates to gearboxes, particularly though not exclusively to automotive gearboxes, and is concerned with that type of gearbox which includes an input shaft, an output shaft and a plurality of pairs of meshing gearwheels, at least some of the gearwheels including a respective selectively operable rotary lock which is adapted to lock the gearwheel to the associated shaft so that it rotates therewith.

U.S. Pat. No. 4,987,790 discloses a gearbox of this type including an input shaft carrying a plurality of gearwheels, all of which are permanently connected to rotate therewith and are in mesh with a respective gearwheel carried by an output shaft parallel to but radially spaced from the input shaft. Each gearwheel on the output shaft may rotate with respect to the output shaft but may be selectively locked to it by a rotary lock. Each gearwheel on the output shaft has an axially extending annular projection constituting an engagement outer whose inner surface constitutes an outer race, which is opposed to an engagement inner connected to rotate with the output shaft. The engagement inner affords a plurality of surface portions associated in pairs, each pair defining together with the outer race a space, whose width in the radial direction decreases from a maximum value in both circumferential directions. Accommodated in each space is a roller and all the rollers are retained in a common annular cage to rotate in unison about the output shaft. When the rollers are centrally locked in the spaces, the engagement inner and engagement outer may freely rotate relative to another. However, if the rollers move in either circumferential direction they will become jammed between the engagement inner and outer and will lock them together in one or other direction of rotation. An actuator, which is keyed to rotate with the output shaft but is movable along its length, carries three actuator portions with bevelled edges which are selectively insertable into corresponding recesses, which also have bevelled edges, on the associated cage. When the actuator portions are to be engaged in the recesses, the cooperating bevelled surfaces move the associated rollers into positions in which relative rotation of the engagement inner and outer is possible. When the actuator portions are retracted from the recesses, the rollers are carried round by the relative rotation of the engagement inner and outer into positions in which they become jammed and lock the gearwheel to the shaft.

If the relative speed of rotation of the engagement inner and outer is high, when it is desired to lock them together, the rollers may be caused to move so rapidly in the circumferential direction that they do not reliably jam but instead bounce out of the jammed position. This not only means that the selection of a gear ratio may be associated with a certain jerkiness of movement but can also result in damage to the surfaces of the engagement inner and outer. If a vehicle in which the gearbox is installed should move from the drive to the overrun condition, the rollers will be caused to move out of the jammed position down the slope of the associated surface portion and then up the slope of the adjacent oppositely inclined surface portion until they again become jammed and can transmit torque in the reverse direction, that is to say from the wheels of the vehicle to the engine. However, this necessarily requires the rollers to move a relatively long distance and such movement or backlash can also result in jerkiness of motion of the vehicle and/or unacceptable noise generation, particularly when regularly cycling between the drive and overrun conditions.

According to the present invention, there is provided a gearbox including an input shaft, an output shaft and a plurality of meshing pairs of gearwheels, at least one gearwheel of each meshing pair of gearwheels including two respective selectively operable rotary locks which are adapted to lock the gearwheel to the associated shaft so that it rotates therewith in respective opposite directions, each rotary lock comprising a respective plurality of rolling bodies, whose positions relative to one another are maintained by a respective cage and which are received in respective spaces defined between an internal cylindrical surface on the associated gearwheel and a respective portion of the surface of the associated shaft, or a member connected to rotate therewith, the spaces associated with the two sets of rolling bodies having a width in the radial direction of the shaft which progressively decreases from a maximum value in opposite circumferential directions of the shaft, whereby the two cages and thus the rolling bodies associated with them are movable in respective opposite circumferential directions between a freewheel position, in which the rolling bodies are accommodated within the widest portions of the associated spaces and relative rotation of the gearwheel and the shaft is not prevented, and a locked position, in which the rolling bodies are in jamming contact with the internal surface of the gearwheel and the said surface portions and relative rotation of the gearwheel and the shaft is thus prevented in respective opposite directions, each cage being acted on by at least one respective actuating mechanism which is selectively operable to move the cage and thus the associated rolling bodies in the circumferential direction in which the width of the associated spaces decreases from the freewheel position to the locked position.

Thus the gearbox in accordance with the present invention includes a plurality of meshing pairs of gearwheels, at least one gearwheel of each pair including two selectively operable rotary locks which are, so to speak, oppositely handed and are adapted to lock the gearwheel to the associated shaft in opposite directions. At least one actuating mechanism acts on each cage and is adapted to move the cage and thus the rolling bodies associated with it from the freewheel position to the locked position. In use, the lockable gearwheel of all but one of the pairs of meshing gearwheels is unlocked and thus freewheels with respect to the shaft on which it is carried. However, the lockable gearwheel of that meshing pair of gearwheels through which torque is being transmitted is locked to its associated shaft in both directions, that is to say both of its rotary locks are in the locked position. Accordingly, the backlash problem referred to above in connection with the construction of U.S. Pat. No. 4,987,790 is completely eliminated because when the engine moves from the drive condition to the overrun condition or vice versa no rolling bodies need move at all and there is therefore a smooth and instantaneous transition between the transmission of torque from the engine to the wheels and the transmission of torque from the wheels to the engine and vice versa. Furthermore, the rolling bodies in the gearbox in accordance with the present invention no longer rely on the force applied to them by the differential speed of the gearwheel and the associated shaft to move them from the freewheel position to the locked position but are instead positively moved into the locked position by one or more actuators acting on the associated cage. This positive movement of the cage and rolling bodies means that the movement into the locked position is more positive and reliable, even at low speed differentials, and eliminates any risk of the rolling bodies bouncing out of the jammed position.

In the gearbox in accordance with the present invention there are two arrays of surface portions on the surface of the associated shaft, or a member connected to rotate therewith, which are inclined to the tangential direction, the surface portions of each array being inclined in the same sense but in the opposite sense to the surface portions of the other array. The two arrays of surface portions may extend in a single annular series of surface portions of alternating inclination, as in the prior U.S. patent referred to above, with the two sets of rolling bodies axially spaced from one another and retained in respective cages. However, it is preferred that the two arrays of surface portions are axially spaced from one another, that is to say spaced apart in the direction of the length of the associated shaft, because this permits twice as many rolling bodies to be used which means that the torque is transmitted through a larger area. The two axially spaced arrays of surface portions may be provided on a single hub keyed to rotate with the associated shaft but it is preferred that they are provided on respective hubs, each of which is keyed to rotate with the associated shaft.

Whilst it would be sufficient for there to be a single actuating mechanism acting on each cage, it is preferred that there are two such mechanisms acting on each cage at substantially diametrically opposed positions because this results in smoother and more reliable operation. The two actuating mechanisms acting on each cage will of course normally be connected to act in the same sense and to move in synchronism. However, if it is desired to provide positive actuation of the cages both into and out of the locked position, the two actuators could be arranged to act on the associated cage in opposite directions, whereby one actuator will move the cage from the freewheel position to the locked position and the other actuator will move the cage from the locked position to the freewheel position.

All the actuating mechanisms acting on the cages associated with each lockable gearwheel may be arranged to move in synchronism, whereby the gearwheel is either completely free to rotate with respect to the associated shaft or is wholly locked to it in both directions, and in this event the actuating mechanisms acting on both cages will be connected to a common pressurised fluid supply passage. However, it is also possible for the actuating mechanisms associated with the two cages of each lockable gearwheel to be independently actuable, thereby permitting the gearwheel to be selectively lockable to the shaft in one direction only, and in this event the actuating mechanisms acting on the two cages will be connected to respective pressurised fluid supply passages. If there are two actuators acting in opposite senses on each cage then each actuator will of course have to be connected to a respective pressurised fluid supply passage.

The actuating mechanisms may be of any appropriate type but it is preferred that they include a fluid operated piston which is movable against the action of a restoring spring against one limb of a bell crank, which engages the associated cage and is adapted to move it in the circumferential direction, that is to say towards the locked position.

In practice, when each actuating mechanism is retracted, that is to say the fluid pressure is removed from the piston which then returns to its rest position under the action of the restoring spring, the cage and associated rolling bodies will be returned to the freewheel position by virtue of the relative rotation of the shaft and gearwheel. However, in order to assist this return movement and to ensure that the cage remains stably in the freewheel position and also to eliminate any centrifugal effects, it is preferred that each rotary lock includes spring means cooperating with the cage and urging it in the circumferential direction towards the freewheel position. Alternatively, as mentioned above, an actuator may be provided to positive move each cage into the freewheel position.

The gearbox may be of any of a number of known types and the invention is applicable to any gearbox which includes a plurality of pairs of meshing gearwheels. In one embodiment, the input shaft is parallel to the output shaft but spaced therefrom in a radial direction, the input shaft carrying a plurality of gearwheels which are in mesh with respective gearwheels carried by the output shaft, only one gearwheel of each meshing pair including two selectively operable rotary locks. Such a gearbox is of generally conventional construction and incorporates one meshing pair of gearwheels for each gear ratio of the gearbox. In this case, it is preferred that every alternate gearwheel on the input shaft includes two respective rotary locks and the remaining gearwheels on the input shaft are permanently connected to rotate therewith. In the most preferred embodiment, each gearwheel on the input shaft and output shaft which is fixed to the associated shaft is of reduced thickness in the axial direction in the radially inner portion of its radial extent, thereby defining a recess, a portion of the adjacent gearwheel including two rotary locks being accommodated in the recess. Thus in this preferred embodiment, adjacent pairs of gearwheels on the same shaft are partially “nested” within one another, thereby reducing the overall length of the gearbox.

In an alternative embodiment, the input shaft and output shaft are substantially coaxial and the gearbox additionally includes a layshaft parallel thereto, the input shaft carrying a gearwheel in mesh with a gearwheel carried by the layshaft, the layshaft carrying further gearwheels which are in mesh with respective gearwheels carried by the output shaft. In such a gearbox it is desirable for both gearwheels of a meshing pair of gearwheels to be provided with a respective pair of rotary locks because by appropriate selection of the torque path through the gearbox it is possible for the gearbox to provide a number of gear ratios which exceeds the number of meshing pairs of gearwheels.

Whilst the present invention has been described principally in relation to gearboxes, it will be appreciated that the invention may be applicable to any gearwheel which is to be selectively lockable to a shaft and the present invention thus also relates to a gearwheel selectively lockable to a rotary shaft by two rotary locks as defined above. The locking mechanism may also be used as a selectively operable shaft coupling or clutch. In this event the adjacent ends of two coaxial shafts will be surrounded by a common cylindrical shell, the two rotary locks being positioned between the internal surface of the shell and the external surface of respective shafts. The selective actuation of the locks will permit the two shafts to be locked together in one or both directions or to rotate freely with respect to one another. Alternatively, one end of one shaft, or a member connected to rotate therewith will extend coaxially around one end of the other shaft, the two “oppositely handed” locks being situated between the two opposed cylindrical surfaces.

Further features and details of the invention will be apparent from the following description of certain specific embodiments in accordance with the invention which is given by way of example with reference to the accompanying drawings, in which:

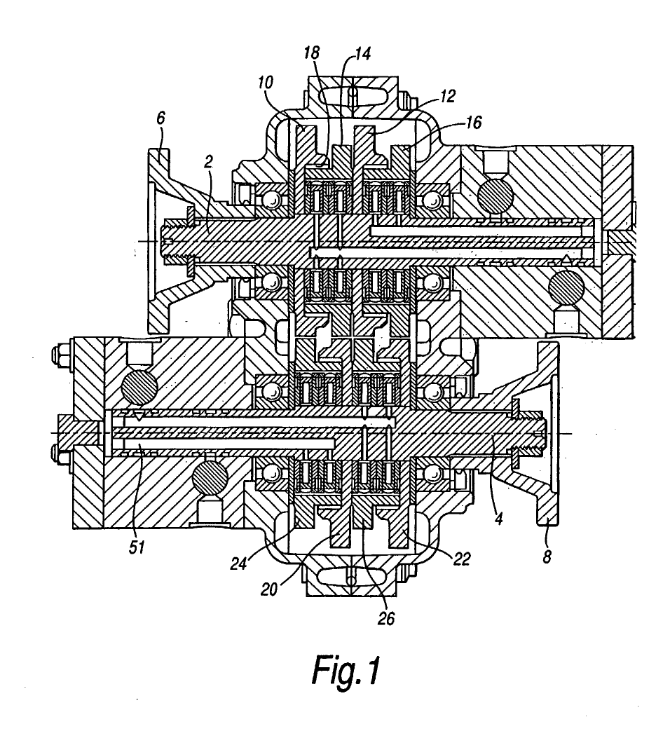

FIG. 1 is a longitudinal sectional view of a four-speed gearbox;

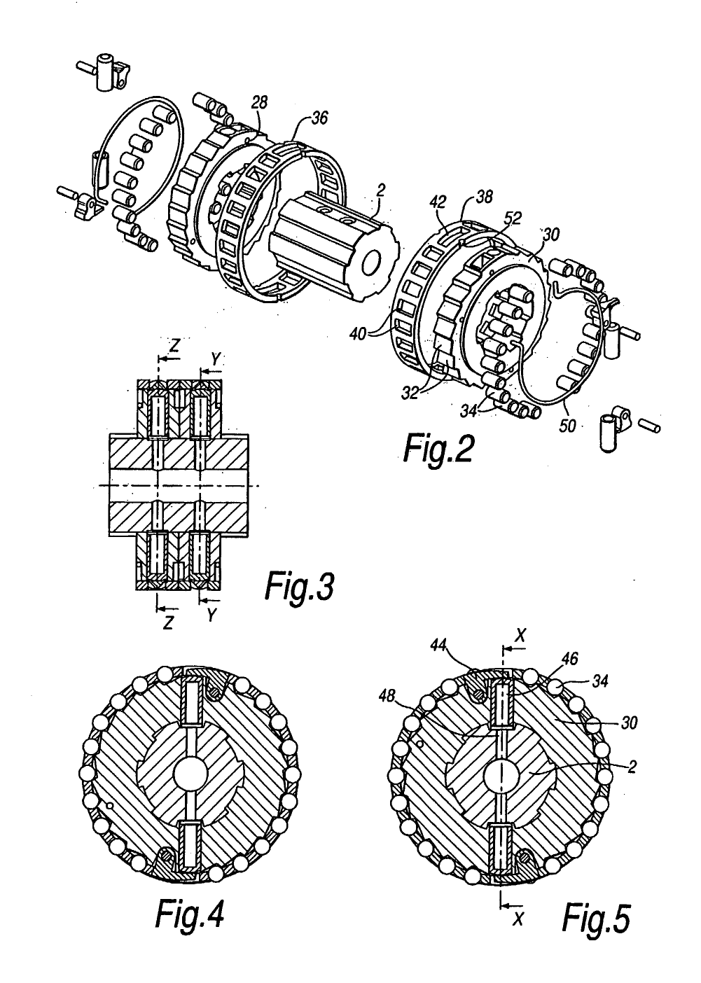

FIG. 2 is an exploded perspective view of the two selectively operable rotary locks located within certain of the gearwheels;

FIG. 3 is an axial sectional view of the two rotary locks on the line X-X in FIG. 5 from which the hubs, cages and rolling bodies have been omitted for the sake of clarity; and

FIG. 4 is a radial sectional view of one of the rotary lock on the line Z-Z in FIG. 3;

FIG. 5 is a radial sectional view of the other rotary lock on the line Y-Y in FIG. 3; and

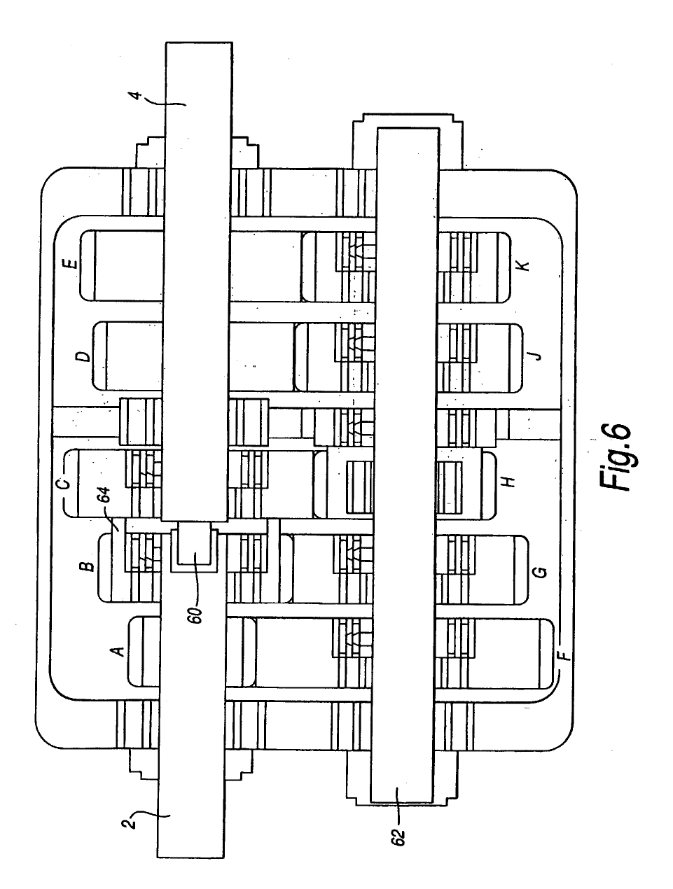

FIG. 6 is a highly diagrammatic side view of an alternative construction of gearbox in accordance with the invention.

The gearbox shown in FIGS. 1 to 5 comprises a rotatable input shaft 2, parallel to and radially spaced from which is a rotatable output shaft 4. The input and output shafts 2, 4 carry respective drive connection flanges 6, 8. Permanently secured to the input shaft so as to rotate therewith are two fixed gearwheels 10, 12, alternating with which are two further gearwheels 14, 16 which are connected to the shaft 2 by two rotary locks, each of which is selectively movable between a freewheel position, in which relative rotation of the shaft 2 and the associated gearwheel is permitted, and a locked position in which the gearwheel is rotationally locked to the shaft 2 in one direction only. The two rotary locks are oppositely “handed”, whereby when they are both locked the gearwheel is wholly locked to the shaft. Each adjacent pair of gearwheels 10, 14 and 12, 16 are “nested”, that is to say the radially inner portion of each fixed gearwheel 10, 12 affords an annular recess 18 in which a portion of the associated lockable gearwheel is accommodated. This results in a reduction in the axial length of the gearbox.

The output shaft 4 also carries four gearwheels arranged in similar nested pairs, that is to say two fixed gearwheels 20, 22, which are in mesh with respective lockable gearwheels 14, 16 on the input shaft and two lockable gearwheels 24, 26, which are in mesh with respective fixed gearwheels 10, 12 on the input shaft. Each lockable gearwheel 24, 26 contains two rotary locks which are constructed and operate in the same manner as those provided in the lockable gearwheels on the input shaft.

One of the pairs of the selective rotary locks will now be described with reference to FIGS. 2 to 5 which relate equally to all of the gearwheels 14, 16, 20, 22 but will be supposed to relate specifically to the gearwheel 14. Keyed to the input shaft 2 to rotate with it are two annular hubs 28 and 30. The gearwheel 14 (which is not shown in FIGS. 2 to 5) is annular and its internal surface is smoothly cylindrical. The hubs 28 and 30 are generally of ratchet wheel shape and thus have a number, in this case 20, of “flats”, i.e. planar surfaces 32 on their outer periphery. The planar surfaces 32 on each hub are all inclined in the same sense to the tangential direction but those on the hub 28 are oppositely inclined to those on the hub 30, as seen in FIGS. 4 and 5. Closely spaced, e.g. only by an oil film, from one end of each flat 32, is a rolling body 34, in this case a roller, which is also in rolling contact with the opposed internal cylindrical surface of the gearwheel 14. The rolling bodies 34 associated with each hub are all retained in a respective annular cage 36, 38 which maintains their spacing constant. Each hub together with the associated cage, rollers and other components constitutes a rotary lock and the two locks are identical in all respects except one, namely that they are “oppositely handed” and thus lock in opposite directions. Accordingly, for the sake of simplicity, only one of the locks will be further described, and this will be presumed to be the right-hand lock, as seen in FIG. 2. When the rolling bodies 34 are in alignment with the ends of the flats 32 at which the spacing of the flats from the opposed surface of the gearwheel is at a maximum, as shown in FIG. 5, relative rotation of the gearwheel and of the shaft 2, and the hub 30 keyed to it, is possible by rolling motion of the rollers 34 with respect to the two opposed surfaces with which it is substantially in contact.

The rollers 34 are retained in respective apertures 40 in the cage 38. The cage also affords two larger, diametrically opposed rectangular apertures 42 in which one limb of a respective bell crank 44 is received. The bell crank is pivotally mounted on the hub 30 at the free end of one of its limbs and engages one end of the associated aperture 42 at the junction of its two limbs. The free end of the other limb is acted on transverse to its length by an actuating piston 46 which is associated with a return spring (not shown) and is exposed to a hydraulic passage 48. Two part-annular springs 50, of which only one are shown, are anchored to the hub 30 at one end and engage the cage 38 at the other end, in a respective recess 52, and urge the cage to rotate with respect to the hub in the clockwise direction, as seen in FIG. 5.

Each of the shafts 2 and 4 is hollow and also defines a number of pressurised oil passages 51, which is at least equal to the number of selectively lockable gearwheels carried by it and may be equal to the number of rotary locks carried by it. These passages are connected to a common relatively low pressure oil pump, which may be mechanically coupled to be driven by an element of the gearbox or the associated engine or may be driven by a separate motor, e.g. an electric motor. A filter, valves and, if required, a cooler may also be provided. The oil pump may also supply lubricating oil to wherever it is required thus permitting the gearbox to operate with a “dry sump”, thereby eliminating the conventional parasitic power loss.

The gearbox has four pairs of meshing gearwheels, the two gearwheels of each pair being carried by the input shaft and output shaft, respectively. One gearwheel of each pair is rigidly connected to its associated shaft and the other is selectively lockable. In use, the lockable gearwheel of the pair of gearwheels through which torque is being transmitted is locked to its associated shaft in both directions by the application of hydraulic pressure to the pistons 46 of both its locks. Torque may thus be transmitted from the engine to the wheels in the drive condition and from the wheels to the engine in the overrun condition. If it is desired to change up a gear, the lock which permits overrunning is released by removing hydraulic pressure from its pistons 46. Drive torque continues to be transmitted but the rollers 34 of the freewheel lock move under the action of the springs 50 to the position in which they are not jammed, i.e. to the end of the spaces of the greatest height. The drive between the engine and gearbox is then briefly interrupted, e.g. by some form of clutch and both locks of the lockable gearwheel of the pair of gearwheels of the next ratio are then locked by the application of hydraulic pressure to its pistons which moves both sets of rollers into the locked position. The input shaft then slows down and the rollers of the drive hub of the previous gear ratio then move into the unlocked or freewheel position, after removal of hydraulic pressure from the associated pistons, under the action of the associated springs 50 and/or the drag applied to them by the slower rotating output shaft.

An alternative construction of gearbox is shown diagrammatically in FIG. 6. The gearbox includes a rotatable input shaft 2, coaxial with which is an output shaft 4. The output shaft 4 carries a stub shaft 60 of reduced diameter on its end which is freely rotatably received in a circular section recess in the opposed end of the input shaft. Parallel to the shafts 2, 4 and spaced from them is a layshaft 62. Fixedly attached to the input shaft 2 is a gearwheel A which is in permanent mesh with a gearwheel F which is carried by the layshaft 62 and is selectively lockable to it in both directions by two rotary locks, whose construction is the same as that described above. Also connected to the input shaft by a pair of rotary locks is a further gearwheel B which is in permanent mesh with a gearwheel G which is carried by the layshaft and connected to it by two further rotary locks. The layshaft also carries three more gearwheels H, J and K, each of which is in permanent mesh with a respective gearwheel C, D and E carried by the output shaft. All of these gearwheels are connected to their respective shafts by further pairs of selective rotary locks with the exception of two of them, in this case the gearwheels D and E, which are rigidly connected to the put shaft. Gearwheel C on the output shaft is permanently connected to gearwheel B on the input shaft by a connection 10 so that these two gearwheels always rotate at the same speed.

In the specific embodiment, gearwheel A has 17 teeth, B has 33 teeth, C 48 teeth, D 36 teeth, E 44 teeth, F 54 teeth, G 40 teeth, H 22 teeth, J 32 teeth and K 28 teeth. Although there are only three gearwheels on the output shaft in mesh with gearwheels on the layshaft and five meshing pairs of gears in all, the gearbox can provide a total of nine forward ratios.

When the gearbox shown in the drawings is in neutral, all the rotary locks are released. Accordingly, gearwheel A rotates gearwheel F but this is not locked to the layshaft and the layshaft therefore does not rotate. The input shaft is also not locked to gearwheel B. The output shaft therefore does not rotate.

In first gear, the rotary locks on gearwheels F, H and C are locked and the remainder released. Power therefore flows from the input shaft to the output shaft through gearwheels A, F, H and C.

In second gear, the rotary locks on gearwheels F and K are locked and power therefore flows through gearwheels A, F, K and E.

In third gear, the rotary locks on gearwheels F and J are locked and power flows through gearwheels A, F, J and D.

In fourth gear, the rotary locks on gearwheels F, G and C are locked and power flows through gearwheels A, F, G and B and thence to the output shaft via gearwheel C by virtue of the fact that gearwheels B and C are rigidly connected together.

In fifth gear, the rotary locks on gearwheels B, G and K are locked and power flows through gearwheels B, G, K and E.

In sixth gear, the rotary locks on gearwheels B, G and J are locked and power flows through gearwheels B, G, J and D.

In seventh gear, the rotary locks on gearwheels B and C are locked which means that the input shaft and output shaft are effectively connected together and the two shafts rotate at the same speed.

In eighth gear, the rotary locks on gearwheels B, H and K are locked and power flows through gearwheels B and C, due to the fact that they are connected together, and thence through gearwheels H, K and E.

In ninth gear, the rotary locks on gearwheels B, H and J are locked and power flows through gearwheels B, C, H, J and D.

1. A gearbox including an input shaft, an output shaft and a plurality of meshing pairs of gearwheels, at least one gearwheel of each meshing pair of gearwheels including two respective selectively operable rotary locks which are adapted to lock the gearwheels to the associated shaft so that it rotates therewith in respective opposite directions, each rotary lock comprising a respective plurality of rolling bodies, whose positions relative to one another are maintained by a respective cage and which are received in respective spaces defined between an internal cylindrical surface on the associated gearwheel and a respective portion of the surface of the associated shaft, or a member connected to rotate therewith, the spaces associated with the two sets of rolling bodies having a width in the radial direction of the shaft which progressively decreases from a maximum value in opposite circumferential directions of the shaft, whereby the two cages and thus the rolling bodies associated with them are movable in respective opposite circumferential directions between a freewheel position, in which the rolling bodies are accommodated within the widest portions of the associated spaces and relative rotation of the gearwheel and the shaft is not prevented, and a locked position, in which the rolling bodies are in jamming contact with the internal surface of the wheel and the said surface portions and relative rotation of the gearwheel and the shaft is thus prevented in respective opposite directions, each cage being acted on by at least one respective actuating mechanism which is selectively operable to move the cage and thus the associated rolling bodies in the circumferential direction in which the width of the associated spaces decreases from the freewheel position to the locked position.

2. A gearbox as claimed in claim 1 in which there are two respective actuating mechanisms which act on each cage at substantially diametrically opposed positions.

3. A gearbox as claimed in claim 1 or claim 2 in which each actuating mechanism includes a fluid operated piston which is movable against the action of a restoring spring against one limb of a bell crank, which engages the associated cage and is adapted to move it in the circumferential direction.

4. A gearbox as claimed in claim 3 in which the actuating mechanisms acting on both cages are connected to a common pressurised fluid supply passage.

5. A gearbox as claimed in claim 3 in which the actuating mechanisms acting on the two cages are connected to respective pressurised fluid supply passages.

6. A gearbox as claimed in any one of the preceding claims including spring means cooperating with each cage and urging it towards the freewheel position.

7. A gearbox as claimed in any one of the preceding claims in which there is a single annular array of spaces of progressively decreasing width, the width of each adjacent pair of spaces decreasing in the opposite sense, the rolling bodies associated with the two cages being spaced from one another in the axial direction of the associated gearwheel.

8. A gearbox as claimed in any one of claims 1 to 6 in which there are two annular arrays of spaces of progressively decreasing width, the width of the two arrays of spaces decreasing in opposite senses, the two arrays of spaces being spaced from one another in the axial direction of the associated gearwheel.

9. A gearbox as claimed in any one of the preceding claims in which the input shaft is parallel to the output shaft but spaced therefrom in the radial direction, the input shaft carrying a plurality of gearwheels which are in mesh with respective gearwheels carried by the output shaft, only one gearwheel of each meshing pair including two selectively operable rotary locks.

10. A gearbox as claimed in claim 9 in which every alternate gearwheel on the input shaft includes two respective rotary locks and the remaining gearwheels in the input shaft are permanently connected to rotate therewith.

11. A gearbox as claimed in claim 10 in which each gearwheel on the input shaft and output shaft which is fixed to the associated shaft is of reduced thickness in the axial direction in the radially inner portion of its radial extent thereby defining a recess, a portion of the adjacent gearwheel including two rotary locks being accommodated in the recess.

12. A gearbox as claimed in any one of claims 1 to 8 in which the input shaft and output shaft are substantially coaxial and which additionally includes a layshaft parallel thereto, the input shaft carrying a gearwheel in mesh with a gearwheel carried by the layshaft, the layshaft carrying further gearwheels which are in mesh with respective gearwheels carried by the output shaft.
